(19) United States
(12) Patent Application Publication
(10) Pub. No.: US 2016/0019478 A1
(43) Pub. Date: Jan. 21, 2016

(54) OPTION-BASED DISRUPTION MITIGATION SYSTEM IN A LOGISTICS NETWORK

(71) Applicant: Caterpillar Inc., Peoria, IL (US)

(72) Inventors: Steven Ray LEWIS, Peoria, IL (US); Daniel Jonathon STANTON, Charlotte, NC (US)

(73) Assignee: CATERPILLAR INC., Peoria, IL (US)

(21) Appl. No.: 14/335,255

(22) Filed: Jul. 18, 2014

(51) Int. Cl. G06Q 10/06; G06Q 10/08

(52) U.S. Cl. CPC G06Q 10/0635; G06Q 10/08

(57) ABSTRACT

A disruption mitigation system for a network is disclosed. The system has at least one processor and a memory module configured to store instructions that when executed enable the at least one processor to receive a data set, the data set indicative of at least one option for mitigating an event that disrupts at least one component of the network. The instructions further enable the at least one processor to determine a probability of occurrence of the event by randomly sampling a specified probability space and estimate a cost of the at least one option based on the probability.

### TECHNICAL FIELD

The present disclosure generally relates to systems and methods for mitigating disruption in a logistics network, and more particularly, to option-based disruption mitigation systems and methods.

### BACKGROUND

Companies may use a coordinated network of organizations, people, activities, information, and resources to bring products and/or services to market or simply to ship parts needed for manufacturing new products. Such a network may be referred to as a logistics network. Entities involved in the logistics network may include suppliers, manufacturers, service centers, distribution centers, marketing centers, sales entities, dealers, and the like. Each entity may be thought of as a node, and the channels through which these entities interact may be thought of as links. Links may be, for example, a communication network, a road, an air traffic corridor, or a railway.

A logistics network may experience failure at the node level, at the link level, or at both levels. The failure may be a result of an event that disrupts a node or a link. For example, an organization whose logistics network includes a supply chain that utilizes air transportation systems will experience failure if airline pilots go on strike. Similarly, if sea port employees go on strike, organizations that use sea-based shipping will incur delay in their planned delivery cycles.

In yet another scenario, failure at a single node or link may place unexpected strain on other nodes or links, leading to additional failures in the network. One notable example illustrating this scenario is the 2010 eruptions of Icelandic volcano Eyjafjallajökull, which caused major disruptions in European air traffic. This disruption in air transportation may have led to unexpected delays in maritime shipping channels as a result of a sudden increase in the utilization of these channels.

Failures in a logistics network may cause significant loss of revenue, brand name devaluation, and loss of market share in the long term. As such, there is a need to prepare for them ahead of time.

One method of anticipating failure in a supply chain of a company's logistics network is described in U.S. Pat. No. 8,626,558, issued to Dudley et al. on Jan. 7, 2014. The '558 patent describes combining an economic impact factor with a supply risk score to assess the overall impact of failure on the company.

The method disclosed in the '558 patent may provide certain benefits that are particularly important for some logistics network failure mitigation applications. Nevertheless, it may nave certain drawbacks. For example, current logistics network management practices do not provide means for evaluating alternatives for mitigating failure when the probability of occurrence of an event causing the failure is not known. Moreover, there are no means for evaluating mitigating alternatives ahead of time when the probability of success of an alternative is not known.

The present disclosure is directed to overcoming one or more of the problems set forth above and/or other problems in the art.

### SUMMARY OF THE INVENTION

In one aspect, the present disclosure is directed to a method for mitigating disruption in a network. The method includes receiving, by a processor, a data set indicative of at least one option for mitigating an event that disrupts at least one component of the network. The method further includes determining, by the processor, a probability of occurrence of the event by randomly sampling a specified probability space, and estimating, by the processor, a cost of the at least one option based on the probability.

In another aspect, the present disclosure is directed to a disruption mitigation system for a network. The system includes at least one processor and a memory module configured to store instructions that when executed enable the at least one processor to receive a data set, the data set indicative of at least one option for mitigating an event that disrupts at least one component of the network. The instructions further enable the at least one processor to determine a probability of occurrence of the event by randomly sampling a specified probability space and estimate a cost of the at least one option based on the probability.

In yet another aspect, the present disclosure is directed to a non-transitory computer-readable storage device storing instructions for mitigating disruption in a network, the instructions causing at least one computer processor to perform operations that include receiving a data set indicative of at least one option for mitigating an event that disrupts at least one component of the network. The operations include determining a probability of occurrence of the event by randomly sampling a specified probability space, and they further include estimating a cost of the at least one option based on the probability.

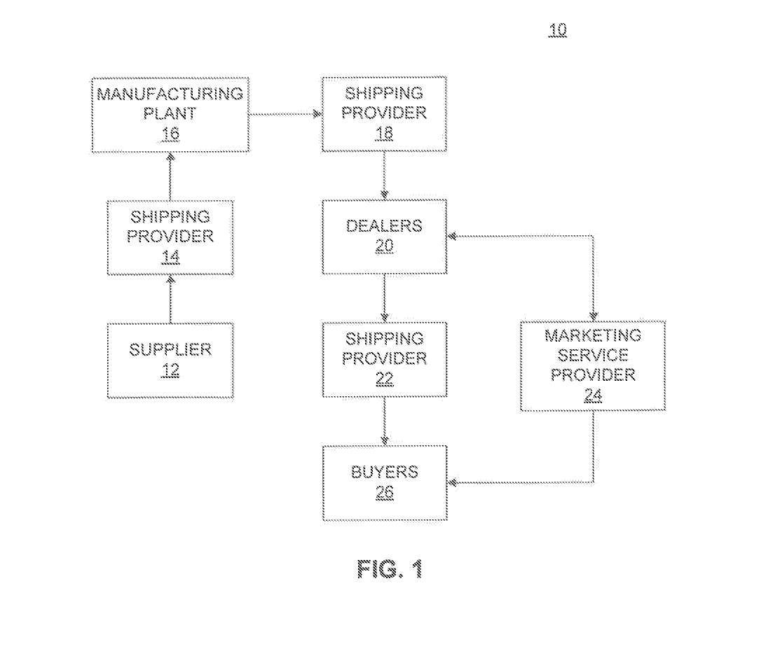

FIG. 1 is a diagrammatic illustration of an exemplary logistics network in which the disclosed embodiments may be implemented.

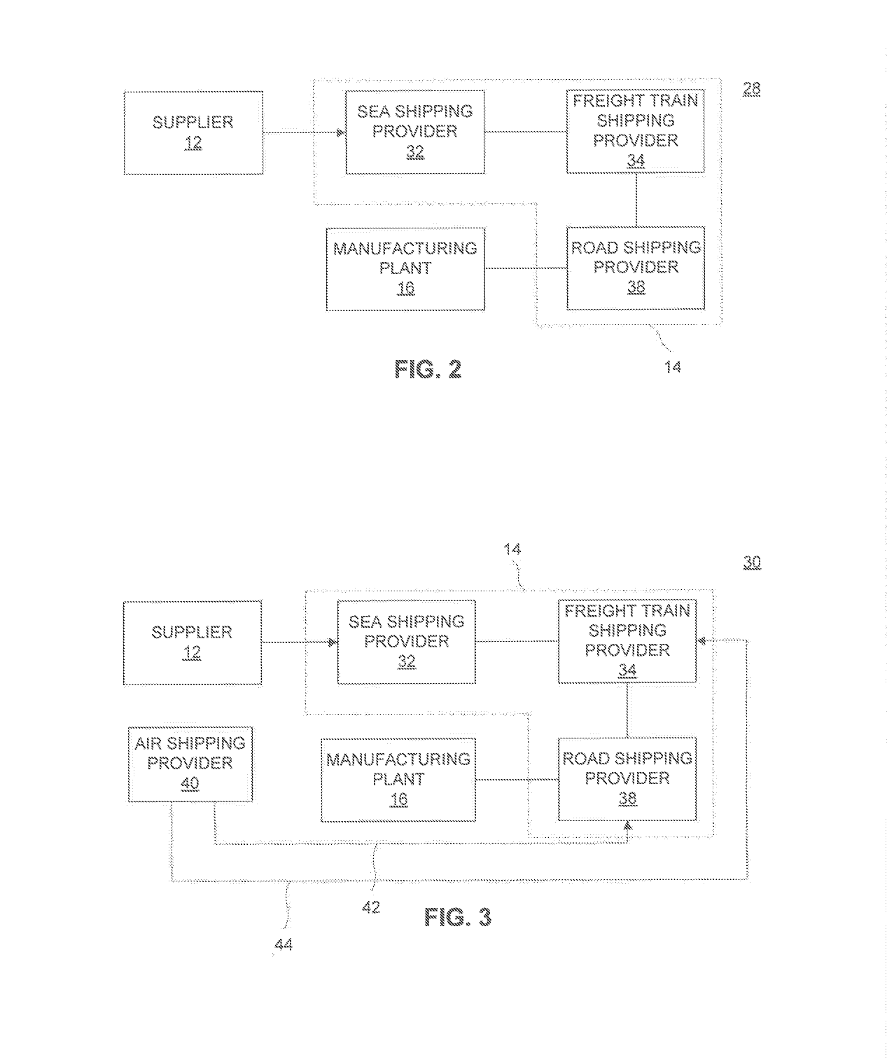

FIG. 2 is a diagrammatic illustration of a supply chain of a logistics network in which the disclosed embodiments may implemented.

FIG. 3 is a diagrammatic illustration of a supply chain of a logistics network in which option-based mitigation alternatives may be implemented, according to an exemplary embodiment.

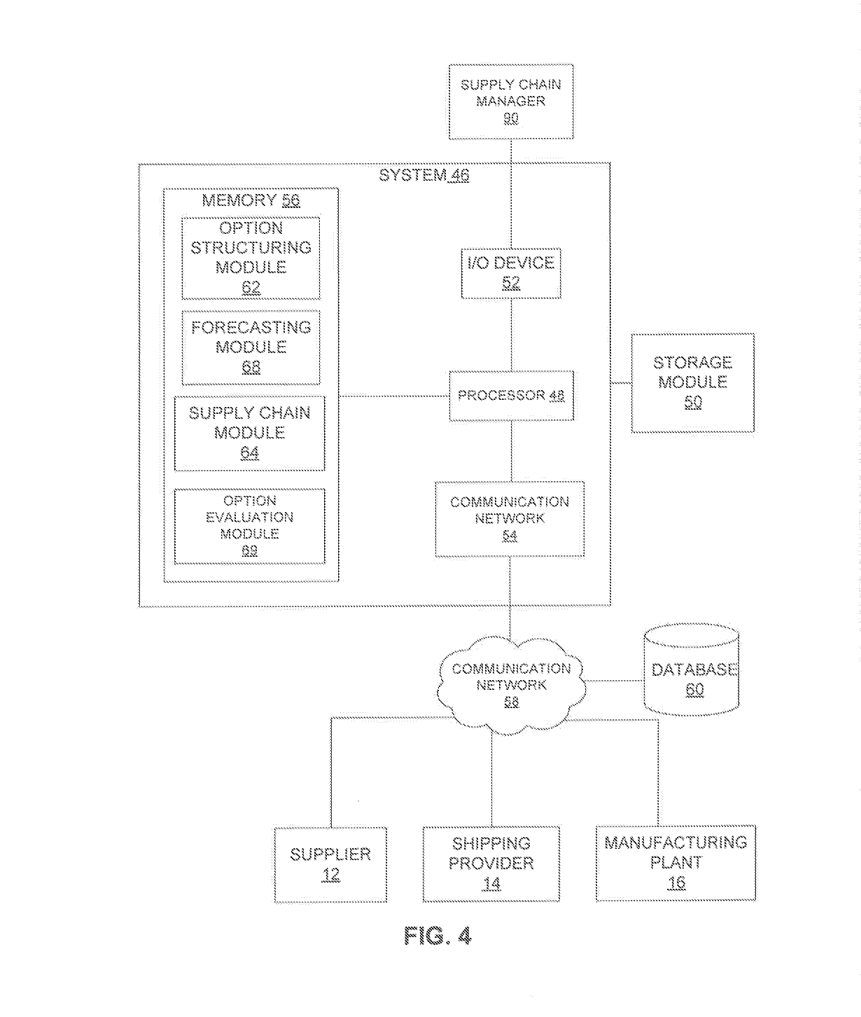

FIG. 4 is a diagrammatic illustration of an option-based mitigation system, according to an exemplary embodiment.

FIG. 5 is a diagrammatic illustration of an option data structure, according to an exemplary embodiment.

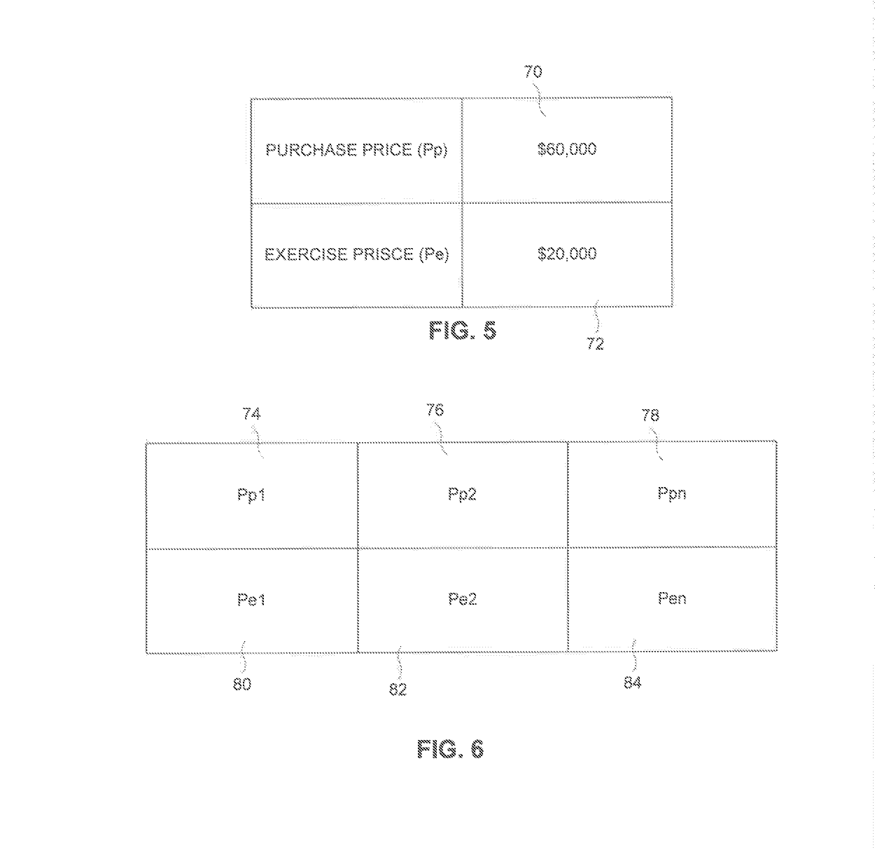

FIG. 6 is a diagrammatic illustration of an option data set, according to an exemplary embodiment.

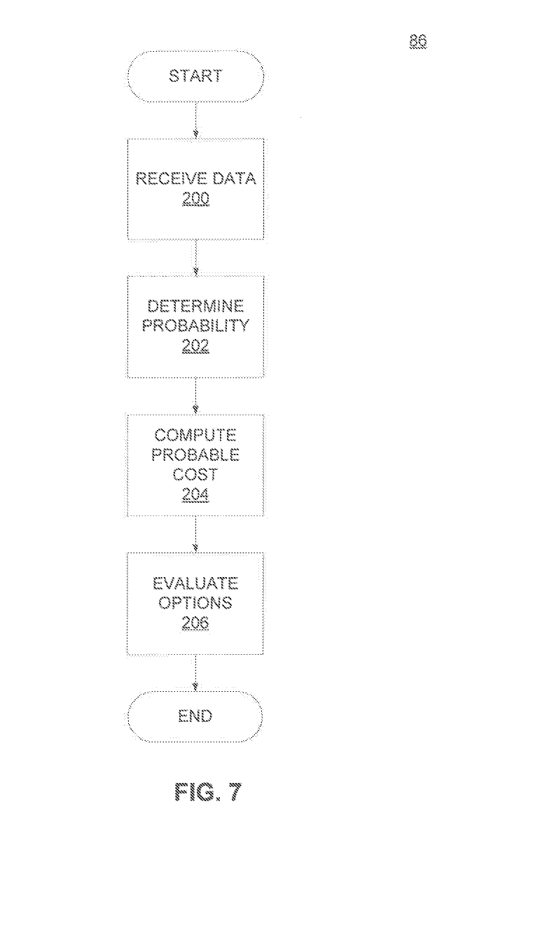

FIG. 7 is flow chart depicting a method, according to an exemplary embodiment.

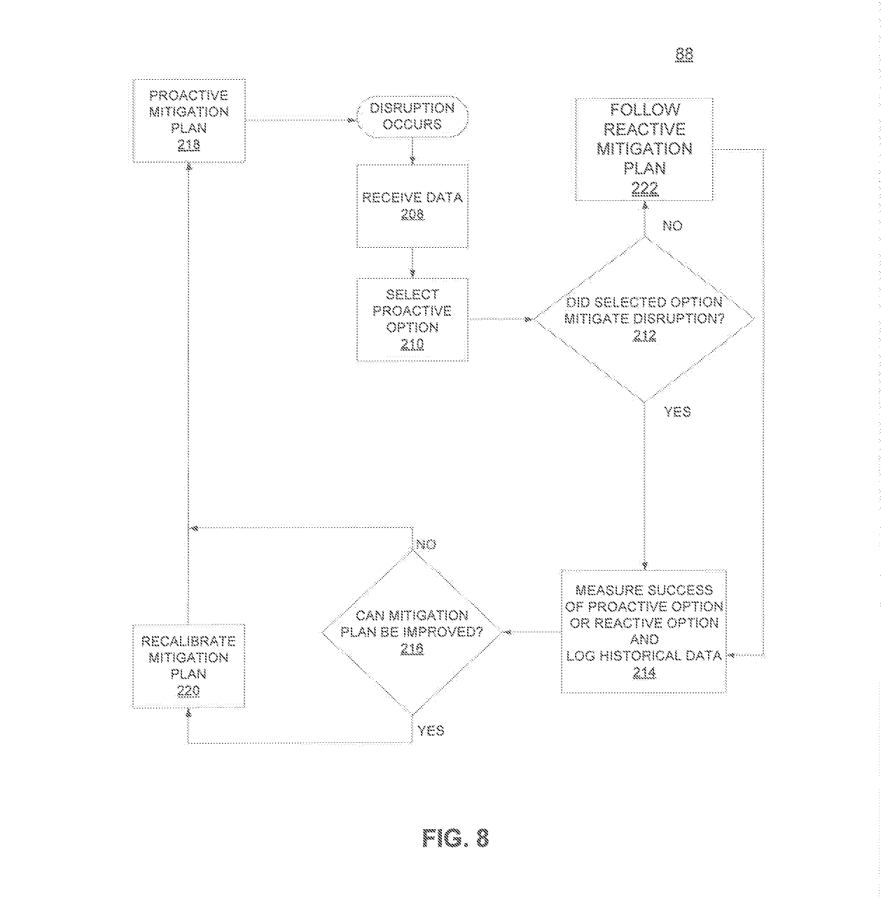

FIG. 8 is a flow chart depicting another method, according to an exemplary embodiment.

### DETAILED DESCRIPTION

FIG. 1 illustrates an exemplary logistics network 10 in which the disclosed embodiments may be implemented. Network 10 may include a plurality of nodes that are interconnected by links (depicted by arrows). The nodes may be for example, supplier 12, shipping provider 14, manufacturing plant 16, shipping provider 18, dealers 20, shipping provider 22, marketing service provider 24, and buyers 26. While FIG. 1 depicts a particular interconnection pattern between the nodes, any number of nodes and interconnection patterns are possible.

In one exemplary network 10, shipping providers 14, 18, and 22 may be sea-based shipping providers, railroad-based shipping providers, and road-based shipping providers, respectively. Further, supplier 12 may be an entity that supplies parts to manufacturing plant 16 via shipping provider 14. The parts may be used at manufacturing plant 16 to fabricate a new part or to service an existing part that will then be shipped to other entities in network 10. Furthermore, shipping provider 18 may route the part finished at manufacturing plant 16 to dealers 16. Dealers 20 may interface with marketing service provider 24 to advertise to potential buyers 26. Marketing service provider 24 may also interface with dealers 20 by providing them market data, customer satisfaction reports, and the like. Furthermore, dealers 20 may use shipping provider 22 to expedite the parts to buyers 26.

One of ordinary skill in the art will readily understand that while FIG. 1 depicts the nodes of network 10 as single entities, each node may have sub-nodes that are interconnected in a given pattern. For example, shipping provider 14 may have a series of sub-nodes and links that cooperatively function to receive a part from supplier 12 and route the part to its point of use, namely to manufacturing plant 16. One such example is discussed below.

FIG. 2 illustrates an exemplary network 10 where shipping provider 14 may include sub-nodes 32, 34, and 38, For example, sub-node 32 may be a maritime shipping service, sub-node 34 a freight train shipping service, and sub-node 38 a road shipping service. For simplicity, when taken together, supplier 12, sub-nodes 32, 34, and 38, and manufacturing plant 16 are referred to as a supply chain (denoted with numeral 28 in FIG 2). One of ordinary skill in the art will readily recognize that the disclosed embodiments may be implemented in a subset of network 10 such as supply chain 28, or they may be applied to network 10 as a whole or to one or more subsets of network 10.

FIG. 3 illustrates supply chain 30 with an option-based mitigation plan. Options may be thought of as measures that are put in place in case a failure happens, much like art insurance policy. Options have a finite period of time over which they are valid. After the validity period has expired, an option may no longer be used.

The option-based mitigation plan may include one or more options for mitigating a failure in supply chain 30. For example, an option 42 may be to expedite a part via air shipping provider 40 to freight train provider 34 when sea shipping provider 32 fails. Another option 44 may be to route the part directly to road shipping provider 52 via air shipping provider 40. Options 42 and 44 may be referred to as “Expedited Transportation” options.

Furthermore, the option-based mitigation plan may include an option (not shown) to remain unresponsive to a failure. Furthermore, the option-based mitigation plan may include an option (not shown) to re-initiate an order after failure occurs at one node. For example, such an option may be to route a duplicate part from supplier 12 to sea shipping provider 32, even after sea shipping provider 32 fails. This option may be referred to as a “Collaborated Order” option. Yet another option may be a “Safety Stock” option, which includes storing an inventory of the part at manufacturing plant 16, the part from the inventory to be used only when supplier 12 is unable to send the part for example due to a failure of sea shipping provider 32. Still another option may be a “Lateral Inventory Transfer” option wherein a duplicate of the part is transferred to manufacturing plant 16 from an inventory of parts of another node of network 10 impervious to the failure of sea shipping provider 32. Another option may be an “Alternate Supplier” option wherein a third party supplier (with its own supply chain) is vetted and contractually bound to ship the part to manufacturing plant 16 in the event of a failure in supply chain 30.

An option may be reactive or it may be proactive. A reactive option may be an option that is exercised in response to a disruption in supply chain 30. In contrast a proactive option may be an option that is exercised prior to a disruption in supply chain 30. For example, the Collaborated Order option, the Expedited Transportation option and the Lateral Inventory Transfer option described above are reactive options. Conversely, the Safety Stock option and the Alternate Supplier option are proactive options.

Furthermore, an option may be an American-style call option or a European-style call option. An American-style call option may be an option that can be exercised at any moment during the validity period. In contrast, a European-style call option may be an option that can be exercised only at a date that coincides with the expiration of the option.

FIG. 4 illustrates a system for mitigating disruption in a supply chain such as supply chain 28, according to an exemplary embodiment. System 46 may include one or more hardware and/or software components configured to display, collect, store, analyze, evaluate, distribute, report, process, record, and/or sort information related to logistics network failure mitigation. System 46 may include one or more of a processor 48, storage module 50, a memory 56, an input/output (I/O) device 52, and a communication network interface 54. System 46 may be connected via a communication network 58 to database 60 and supply chain 28, and to other components of network 10 that are not shown. Supply chain 28 may include supplier 12, manufacturing plant 16, and shipping provider 14, as described above with respect to FIG. 2. Sub-nodes 32, 34, and 38 of shipping provider 14 are not shown for clarity.

System 46 may be a server, client, mainframe, desktop, laptop, network computer, workstation, personal digital assistant (PDA), tablet PC, scanner, telephony device, pager, and the like. In one embodiment, system 46 may be a computer configured to receive and process information associated with different entities involved in the supply chain, the information including purchase orders, inventory data, shipping tracking numbers and statuses, node and link status, and the like. In addition, one or more constituent components of system 46 may be co-located with any one of supplier 12, manufacturing facility plant 16, or with any other component of network 10.

Processor 48 may include one or more processing devices, such as one or more microprocessors from the Pentium™ or Xeon™ family manufactured by Intel™, the Turion™ family manufactured by AMD™, or any other type of processors. As shown in FIG. 4, processor 48 may be communicatively coupled to storage module 50, memory 56, I/O device 52, and communication network interface 54. Processor 48 may be configured to execute computer program instructions to perform various processes and method consistent with certain disclosed embodiments. In one exemplary embodiment, computer program instructions may be loaded into memory 56 for execution by processor 48.

Storage module 50 may include a volatile or non-volatile, magnetic, semiconductor, tape, optical, removable, non-removable, or other type of storage device or computer-readable medium. Storage 50 may store programs and/or other information that may be used by system 46.

Memory 56 may include one or more storage devices configured to store information used by system 46 to perform certain functions related to the disclosed embodiments. In one embodiment, memory 56 may include one or more modules (e.g. 5 collections of one or more programs or subprograms) loaded from storage 50 or elsewhere that perform (i.e., that when executed by processor 48, enable processor 48 to perform) various procedures, operations, or processes consistent with the disclosed embodiments. For example, memory 56 may include a forecasting module 68, an option structuring module 62, a supply chain module 64, and an option evaluation module 69.

Supply chain module 64 may contain instructions, which when executed, cause processor 48 to generate information related to one or more target items at any one of supplier 12, manufacturing plant 16, and shipping provider 14. Processor 48 may also generate historical data associated with any of the target items. Processor 48 may also log information associated with the target items in storage module 50, which can later serve as the aforementioned historical data.

I/O device 52 may include one or more components configured to communicate information associated with system 46. For example, I/O device 52 may include a console with an integrated keyboard and mouse to allow a user to input parameters associated with system 46 and/or data associated with supply chain 28. I/O device 52 may include one or more displays or other peripheral devices, such as, for example, printers, cameras, microphones, speaker systems, electronic tablets, bar code readers, scanners, or any other suitable type of I/O device 52.

Communication network interface 54 may include one or more components configured to transmit and receive data via communication network 58, such as, for example, one or more modulators, demodulators, multiplexers, de-multiplexers, network communication devices, wireless devices, antennas, modems, and any other type of device configured to enable data communication via any suitable communication network.

Communication network interface 54 may also be configured to provide remote connectivity between processor 48, storage 50, memory 56, I/O device 52, and/or database 60, to collect, analyze, and distribute data or information associated with supply chain 28 and mitigation of failure(s) in supply chain 28.

Communication network 58 may be any appropriate network allowing communication between or among one or more computing systems, such as, for example, the Internet, a local area network, a wide area network, a WiFi network, a workstation peer-to-peer network, a direct link network, a wireless network, or any other suitable communication network. Connection with communication network 58 may be wired, wireless, or any combination thereof.

Database 60 may be one or more software and/or hardware components that store, organize, sort, filter, and/or arrange data used by system 46 and/or processor 48. Database 60 may store one or more tables, lists, or other data structures containing data associated with logistics network failure mitigation. For example, database 60 may store operational data associated with each one of supplier 12, manufacturing facility 16, and shipping provider 18, such as inbound and outbound orders, production schedules, production costs, resources, node status, link status, and the like. The data stored in database 60 may be used by processor 48 to receive, categorize, prioritize, save, send, or otherwise manage data associated with supply chain 28.

In one exemplary embodiment, system 46 may be operable to apply options to supply chain 28, effectively transforming supply chain 28 into a supply chain with an option-based mitigation plan like supply chain 30 (see FIG. 3). In the exemplary embodiment depleted in FIG. 4, system 46 may be configured to receive a command to provide failure mitigation options to supply chain 28 from a supply chain manager 90. In another exemplary embodiment, system 46 may be configured to receive the command to apply the options-based mitigation plan to supply chain 28 from a device that is communicatively coupled to system 46 via communication network 58. In yet another embodiment, system 46 may be configured to automatically extract the command from data stored in storage module 50 or in database 60. In yet another exemplary embodiment, system 46 may be operable, using processor 48, to extract the command from data stored in storage module 50 or in database 60 in response to receiving a status of supply chain 28 via communication network 58.

The command may include data indicative of one or more mitigation options. The data may include a first value associated with purchasing a mitigation option. For example, In the case of an “Alternate Supplier” option, the data may include a cost of a premium paid to an alternate supplier to guarantee that a part will be kept in inventory for shipping to manufacturing plant 16 in the event of a disruption in supply chain 28. Moreover, the data may include a cost associated with expenses incurred in vetting the alternate supplier.

Furthermore, the data may include a second value associated with exercising a mitigation option. In the example above, the value associated with exercising the “Alternate Supplier” mitigation option may be the shipping costs incurred by the alternate supplier when it ships the part to manufacturing plant 16 after the disruption of supply chain 28. In another embodiment, the command may include a set of parameters associated with a plurality of mitigation options. System 46 may then compute, using processor 48, the first value and the second value for each option of the plurality of options based on one or more parameter from the set of parameters.

In some exemplary embodiments, the parameters may include, for example, a price of the part, an original transportation cost of the part, and a factor associated with a cost of holding the part in inventory. Systems 46 may then compute the first value based on these parameters. In some embodiments, the first value or the second value may be computed simply by adding the aforementioned parameters, in other embodiments, predefined mathematical functions may be used to compute the first value based on the aforementioned parameters. One of ordinary skill in the art will readily understand that the parameters may vary in nature, depending on the options. For example, for a reactive option, the set of parameters may include costs associated only with exercising the option. In such a case, the option may have no costs associated with purchasing it, which means that the first value is zero.

Options structuring module 62 may include instructions which when executed cause processor 48 to structure the data indicative of the one or more options in a specified format. For example, FIG. 5 illustrates a format wherein the data is associated with one option. The data may then be formatted and stored in an array wherein a first field 70 is reserved for the first value associated with a cost of purchasing the option. Furthermore, the array may include a second field 72 reserved for the second value associated with a cost of exercising of the option. While FIG. 5 illustrates non-zero values for each field, either of field 70 and 72 (or both) may be zero, depending on the option.

FIG. 6 illustrates an exemplary format wherein a plurality of options may be represented in an array format, wherein the first row includes a plurality of first values (only 74, 76, and 78 shown), and the second row includes a plurality of second values (only 80, 82, and 84 shown). While FIGS. 5 and 6 illustrate a specific format, any known format in the art that is suitable for storing data is contemplated. Furthermore, while only two fields are shown, the data may be formatted to include additional fields based on information included in the command or information extracted from elsewhere. Such additional fields may be, for example, an option expiration time field, a field associated with a user that created the option, and/or fields related to how many times the option has been used. Generally speaking, the data may be formatted to include any information associated with the options. Moreover, the data may be stored in storage module 50 or elsewhere in a cache (not shown). The cache may be updated with new data when an expiration time associated with the option has passed.

Referring now to FIG. 4, forecasting module 68 may contain instructions, which when executed, may cause processor 48 to determine a probability of a disruption occurring at one or more nodes and/or at one or more links in the supply chain 28. In some exemplary embodiments, processor 48 may be configured by the Instructions to determine a probability of success (or failure) of a mitigation option, in some exemplary embodiments, forecasting module 68 may contain instructions that cause processor 48 to generate a specified probability space and randomly sample the specified probability space n times, where n is any integer greater than 1. The parameter n may be provided with the command, or it may be extracted from storage module 50 or any other device communicatively coupled to network 10. Furthermore, the instructions may cause processor 48 to determine the probability of disruption by sampling the specified probability space in a specified range of probabilities. In some exemplary embodiments, the specified range of probabilities may be from about 0.5 to 0.9.

Processor 48 may then be operable to compute the probability of disruption by computing an average of the distribution of the n samples obtained from randomly sampling the specified probability space n times, in other exemplary embodiments, processor 48 may be configured to compute a median instead of an average. In other embodiments, processor 48 may be configured to compute a mode instead of an average. Generally speaking, processor 48 may be configured to determine any statistical observable of the distribution of the n samples obtained from randomly sampling the specified probability space.

In one exemplary embodiment, the random sampling of the specified probability space may be a Monte-Carlo process. The specified probability space may be associated with one of a triangular distribution, a normal distribution, and a uniform distribution.

In some exemplary embodiments, processor 48 may be configured by instructions in forecasting module 68 to compute the probability of success of an option structured by the option structuring module 62 using the same methods as described above with respect to computing the probability of disruption. Furthermore, the instructions may cause processor 48 to generate the specified probability space based on parameters included in the command or extracted from elsewhere in network 10. For example, the parameters may include a specified mean and a specified standard deviation for generating the specified distribution.

In some exemplary embodiments, the specified probability space may be associated with a joint probability distribution. The joint probability distribution may be a probability density function associated with at least two or more components (i.e. nodes or link) of supply chain 28. Yet in other exemplary embodiments, the specified probability space may be associated with a conditional probability distribution. The conditional probability distribution may be a probability density function indicative of a status of a first component of supply chain 28, given a status of a second component of supply chain 28.

Option evaluation module 69 may contain instructions, which when executed, cause processor 48 to compute a probable cost of an option based on at least one of the probability of disruption and the probability of success of the option. In some exemplary embodiments, a probable cost of the option may be computed by multiplying the probability of disruption by the sum of the first value of the option, the second value of the option, and a cost associated with the part(s) for which the option is devised. In other exemplary embodiments, the sum may be multiplied by the probability of success of the option to compute the probable cost of the option. In other exemplary embodiments, the probable cost of the option may be computed by multiplying the sum by an average or a product of the two probabilities. Other computations that utilize at least one of the two determined probabilities and the aforementioned sum are also contemplated.

Upon computing the probable cost of the option, processor 48 may be further configured to compare the probable cost of the option with similarly estimated probable costs of other options. Furthermore, processor 48 may he further configured to select, based on the aforementioned comparison, the option with the smallest probable cost. Processor 48 may then forward the selected option to one or more nodes of supply chain 28. One of ordinary skill in the art will readily understand that selection of the best option may be based on parameters other than probable cost. For example, the most expensive option may still be selected if it provides some advantages deemed useful by a user, or if system 46 is programmed to make a selection based on other parameters.

### INDUSTRIAL APPLICABILITY

The disclosed system 46 may be applicable to networks other than network 10. Another exemplary network may be a power delivery grid. System 46 may then be used to mitigate failures at specific power plants in the network. System 46 may then be used to evaluate several contingency plans (options) ahead of time. Generally speaking, the disclosed system 46 may be implemented in networks and subsets thereof wherein failure anticipation and mitigation are desired.

Further, the disclosed system 46 may have several advantages over mitigation and anticipation systems of the prior art. For example, system 46 may be used when the probability of success of an option and/or the probability of a disruption is unknown.

FIG. 7 is a flow chart depicting an exemplary method 86 of mitigating a supply chain, the method 86 being executed by system 46. When executing method 86, system 46 may be configured to perform operations that include receiving data that includes data associated with a mitigation option (step 200), determining a probability based on the received data by randomly sampling a probability space (step 202), and computing a probable cost of the option based on the determined probability (step 204). The data associated with the option may include a first value and a second value, wherein the first value is associated with a cost of purchasing the option and the second value is associated with a cost of exercising the option.

The probability may be a probability of a disruption occurring at one or more nodes and/or at one or more links in a network, such as network 10 in FIG. 1. In some exemplary embodiments, step 202 may include determining a probability of success (or failure) of a mitigation option. In some exemplary embodiments, step 202 may include generating the specified probability space and randomly sampling the specified probability space n times, where n is any integer greater than 1.

Furthermore, step 202 may include determining a probability of disruption by computing an average of the distribution of the n samples obtained from randomly sampling the specified probability space n times. In other exemplary embodiments, step 202 may include computing a median instead of an average. In other embodiments, step 202 may include computing a mode instead of an average. Generally speaking, step 202 may include determining any statistical observable of the distribution of the n samples obtained from randomly sampling the specified probability space.

In one exemplary embodiment, the random sampling of the specified probability space may be a Monte-Carlo process. The specified probability space may be associated with one of a triangular distribution, a normal distribution, and a uniform distribution.

In some exemplary embodiments, step 202 may include computing the probability of success of an option using the same methods as described above with respect to computing the probability of disruption. Furthermore, step 202 may include generating the specified probability space based on parameters included in the data received (step 200).

Method 86 may further include computing a probable cost of an option based on at least one of the probability of disruption and the probability of success of the option (step 204). In some exemplary embodiments, a probable cost of the option may be computed (step 204) by multiplying the probability of disruption with the sum of the first value, the second value, and a cost associated with part(s) for which the option is devised. In other exemplary embodiments, the probable cost of the option may be computed by multiplying the sum by the probability of success of the option. In other exemplary embodiments, the probable cost of the option may be computed by multiplying the sum by one of the average and the product of the two probabilities.

Upon computing the probable cost of the option (step 204), method 86 may include comparing the probable cost of the option with similarly estimated probable costs of other options (step 206). Furthermore, step 206 may include selecting, based on the aforementioned comparison, the option with the smallest probable cost. Alternatively, step 206 may include selecting an option irrespective of the computed probable cost.

FIG. 8 illustrates yet another method 88 wherein system 46 may be used to mitigate failures in a logistics network. Method 88 includes receiving data (step 208) with system 46, the data indicative of a disruption that has occurred. System 46 may then select a proactive option (step 210). Furthermore, system 46 may receive data back from the network, the data indicative of whether the selected option mitigated the disruption. In response to receiving a positive answer (step 212: YES), system 46 may measure the success of the proactive option and then log historical data indicative of the success of the proactive option (step 214). In contrast, in response to receiving a negative answer (step 212: NO), system 46 may instruct a node of the network to follow a reactive mitigation plan (step 222). System 46 may then log historical data indicative of whether the reactive mitigation plan was successful at mitigating the disruption (step 214). System 46 may then determine, based on the historical data, whether to improve the mitigation plan (step 216). If improvements are needed (step 216: YES), system 46 may recalibrate the mitigation plan (step 220) by generating new probabilities and by computing new probable costs for the options. If improvements are not needed (step 216: NO), system 46 may use a previously used proactive option (step 218) to mitigate future disruptions.

It will be apparent to those skilled in the art that various modifications and variations can be made to the disclosed systems. Other embodiments will be apparent to those skilled in the art from consideration of the specification and practice of the disclosed embodiments. It is intended that the specification and examples be considered as exemplary only, with a true scope being indicated by the following claims and their equivalents.

What is claimed is:

1. A method for mitigating disruption in a network, the method comprising:
receiving, by a processor, a data set indicative of at least one option for mitigating an event that disrupts at least one component of the network;
determining, by the processor, a probability of occurrence of the event by randomly sampling a specified probability space; and
estimating, by the processor, a cost of the at least one option based on the probability.

2. The method of claim 1, wherein the at least one option is an American-style call option.

3. The method of claim 1, wherein determining the probability includes using a Monte-Carlo process.

4. The method of claim 3, wherein the specified probability space is associated with a specified probability distribution and a specified range of probabilities.

5. The method of claim 4, wherein the specified probability distribution is one of a triangular distribution, a normal distribution, and a uniform distribution.

6. The method of claim 4, wherein the specified range of probabilities is from about 0.5 to 0.9.

7. The method of claim 1, wherein the at least one component is a node of the network.

8. The method of claim 1, wherein the at least one component is a link of the network.

9. The method of claim 1, wherein the at least one option includes an option for not responding to the event.

10. The method of claim 1, wherein the data set includes a first price and a second price associated with the at least one option.

11. A disruption mitigation system for a network, the system comprising:
at least one processor; and
a memory module configured to store Instructions that when executed enable the at least one processor to:
receive a data set, the data set indicative of at least one option for mitigating an event that disrupts at least one component of the network;
determine a probability of occurrence of the event by randomly sampling a specified probability space; and
estimate a cost of the at least one option based on the probability.

12. The system of claim 11, wherein the at least one option is an American-style call option.

13. The system of claim 11, wherein determining the probability includes using a Monte-Carlo process.

14. The system of claim 11, wherein the specified probability space is associated with a specified probability distribution and a specified range of probabilities.

15. The system of claim 11, wherein the specified probability distribution is one of a triangular distribution, a normal distribution, and a uniform distribution.

16. The system of claim 11, wherein the at least one option includes an option for not responding to the event.

17. A non-transitory computer-readable storage device storing instructions for mitigating disruption in a network, the instructions causing at least one computer processor to perform operations comprising:
receiving a data set indicative of at least one option for mitigating an event that disrupts at least one component of the network;
determining a probability of occurrence of the event by randomly sampling a specified probability space; and
estimating a cost of the at least one option based on the probability.

18. The computer-readable storage device of claim 17, wherein the at least one option is an American-style call option.

19. The computer-readable storage device of claim 17, wherein determining the probability includes using a Monte-Carlo process.

20. The computer-readable storage device of claim 17, wherein the at least one option includes an option for not responding to the event.
